(19) United States
(12) Patent Application Publication
(10) Pub. No.: US 2022/0288712 A1
(43) Pub. Date: Sep. 15, 2022

(54) WELDING PROCESS AND WELDING APPARATUS FOR CARRYING OUT A WELDING PROCESS

(71) Applicant: Fronius International GmbH, Pettenbach (AT)

(72) Inventors: Manuel MAYER, Pettenbach (AT); Andreas WALDHOER, Pettenbach (AT); Wolfgang KALTEIS, Pettenbach (AT); Rick GRUNWALD, Pettenbach (AT)

(73) Assignee: Fronius International GmbH, Pettenbach (AT)

(21) Appl. No.: 17/632,638

(22) PCT Filed: Apr. 28, 2021
(86) PCT No.: PCT/EP2021/061043

§ 371 Date: Feb. 3, 2022

(30) Foreign Application Priority Data
Apr. 29, 2020 (EP) 20171974.7

(51) Int. Cl. B23K 9/095; B23K 9/12; B25J 11/00

(52) U.S. Cl. CPC B23K 9/095; B23K 9/125; B25J 11/005

(57) ABSTRACT

The invention relates to a welding process with a consumable welding wire (5), in particular a cold metal transfer (CMT) welding process for build-up welding, and also to a welding apparatus (1) for carrying out such a welding process. According to the invention, during the welding process a preset melt-off efficiency (Ab) of the welding wire (5) is kept substantially constant, by the average wire feed (vₘₑₐₙ) of the welding wire (5) being controlled, wherein the latest wire feed (v(t)) is measured, the average measured wire feed (vₘₑₐₙ) is compared with a specified average wire feed (v_{soll_mean}) corresponding to the desired melt-off efficiency (Ab), and in accordance with the deviation (Δv) of the average measured wire feed (vₘₑₐₙ) from the specified average wire feed (v_{soll_mean}) as control deviation, the welding current (I), the free wire length of the welding wire (5), the distance of the contact tube of the welding torch from the workpiece (CTWD Contact Tip to Work Distance) and/or the inclination angle of the welding torch (4) are changed as welding parameters (Pᵢ).

The invention relates to a welding process with a consumable welding wire which is fed to a welding torch which is guided by a welding robot, wherein a welding procedure is formed by cyclic alternating of an arc phase and a short circuit phase, and during the arc phase the welding wire is moved in the direction of a workpiece up to contact with a workpiece, and subsequently after formation of a short circuit during the short circuit phase the wire feeding is reversed and the welding wire is moved away from the workpiece, and wherein to establish the welding procedure a plurality of welding parameters are set, wherein during the welding procedure a pre-set melt-off efficiency of the welding wire is kept substantially constant by the average wire feed of the welding wire being controlled, wherein the latest wire feed is measured, the average measured wire feed is compared with a specified average wire feed corresponding to the desired melt-off efficiency.

The invention also relates to a welding apparatus with a welding torch, guided by a welding robot, for feeding a consumable welding wire to a workpiece, and with a welding current source for carrying out a welding process, wherein a welding procedure is formed by cyclic alternating of an arc phase and a short circuit phase, and during the arc phase the welding wire is moved in the direction of a workpiece up to contact with a workpiece, and subsequently after formation of a short circuit, the wire feed is reversed during the short circuit phase and the welding wire is moved away form the workpiece, and wherein a plurality of welding parameters are able to be set to establish the welding procedure, wherein there is provided an input unit for inputting or selecting a desired melt-off efficiency of the welding wire, a measuring device for measuring the latest wire feed, and a control device for controlling the average wire feed of the welding wire to keep constant the desired melt-off efficiency, and the control device is configured for comparing the average measured wire feed with a specified average wire feed corresponding to the preset melt-off efficiency.

In particular, the so-called cold metal transfer (CMT) welding process is the subject of the invention, an arc welding process in which a forward/backward movement of the welding wire is combined with corresponding welding parameters, so that a targeted detaching of the drops of the melted welding wire results, with a minimizing of weld spatters. For example, EP 1 901 874 B1 describes a CMT welding process in which a movement frequency of the welding wire can be specified, and the further welding parameters are controlled automatically.

Owing to the targeted material detachment, CMT welding processes can also be used optimally for build-up welding, the so-called cladding, and for the additive manufacture of metallic shaped bodies, the so-called WAAM (Wire Arc Additive Manufacturing) or similar 3D printing processes. Usually in such welding processes, the welding current is kept constant as one of the most important welding parameters and is controlled accordingly, and a plurality of further welding parameters, such as the welding voltage and the feed speed of the welding wire, is set according to the respective welding task and changed, so that the desired welding current profile results. With a change of the free wire length of the welding wire, the so-called stickout, or of the distance of the welding torch from the workpiece (CTWD, Contact Tip to Work Distance), different melt-off efficiencies occur owing to this constant current behaviour. For specific applications, therefore, no consistent melt-off efficiency can be achieved.

In particular in build-up welding and in additive manufacture, a constant layer thickness of the applied material, therefore as consistent a melt-off efficiency of the consumable welding wire as possible is essential.

A welding process and a welding apparatus of the type according to the subject has become known for example from US 2018/0290228 A1. To achieve consistent deposition rates during the welding process, the amplitudes of the wire feed speed in the direction of the workpiece and away from the workpiece are changed, in order to achieve as consistent average wire feed as possible. The remaining welding parameters, in particular the welding current and the welding voltage are not to be affected by this control.

The object of the present invention therefore consists in creating a welding process and a welding apparatus of the type indicated above, by which a substantially consistent melt-off efficiency can be achieved. The welding process and the welding apparatus are to be able to be implemented as simply and as economically as possible. Disadvantages of the prior art are to be prevented or at least reduced.

This problem is solved from the procedural point of view in that in accordance with the deviation of the average measured wire feed from the specified average wire feed as the control deviation, the welding current, the free wire length of the welding wire, the distance of the contact tube of the welding torch from the workpiece (CTWD Contact Tip to Work Distance), and/or the inclination angle of the welding torch are changed as welding parameters. The process therefore provides a continuous monitoring of the latest feed of the welding wire and a controlling of the average wire feed by corresponding changing of at least one of the named welding parameters as a function of the deviation of the latest wire feed from the specified wire feed. According to the welding task, substantially more welding parameters can also be specified and changed in accordance with the control deviation. Thereby, a substantially constant average wire feed and thus a substantially constant melt-off efficiency of the welding wire is achieved. Under the prerequisite of a consistent welding speed, a consistent thickness of the weld seam thus results, or in build-up welding and in additive manufacture, a consistent thickness of the applied material layer. Depending on the application of the welding process, a varying number of welding parameters can be set and specified to establish the welding procedure.

Preferably, the welding parameters are stored in the form of working points for various melt-off efficiencies and selected according to the control deviation or respectively interpolated between the working points. This adaptation of the control deviation is usually carried out by a welding process controller. For example, up to 150 different values of different welding parameters can establish the respective working point or the so-called welding characteristic. The process according to the invention therefore provides a shifting of the working point or respectively of the welding characteristic as a function of the deviation of the latest average wire feed from the preset wire feed. For particular control deviations, an exact working point will be able to be selected, whereas for other control deviations an interpolation between specified working points will take place, which usually is also calculated from a welding process controller.

An integrating controller is particularly suitable for controlling the average wire feed. Such an integrating controller acts on the control variable through temporal integration of the control deviation. I-controllers are, indeed, relatively slow, which, however, does not signify a disadvantage in this application, and the controller also has no permanent control deviation. In addition, an I-controller can be realized relatively easily.

The realizing of the control loop with a proportional-integrating controller is also conceivable for controlling the average wire feed. In contrast to the I-controller, the PI-controller is somewhat faster and also has no control deviation. The realizing of a PI-controller in terms of circuitry also signifies a relatively minimal effort.

According to a feature of the invention, the latest wire feed is measured every 1 μs to every 50 μs, in particular every 25 μs. Such scanning values have proved to be suitable with regard to the control speed and the effort with regard to measurement technology.

The measured latest wire feed can be averaged over a certain time span, in order to achieve a smoothing of the signal and to prevent false control responses to erroneous measurement values or so-called outliers. Averaging intervals between 10 ms and 1000 ms are suitable here. The mean value formation can take place in blocks or continuously.

When the average wire feed is controlled with a maximum specified rate of increase or respectively slew rate, the speed of the control can be influenced. For example rates of increase in the range between 0.1 m/min and 1 m/min can be selected.

It is advantageous if the average wire feed is controlled with a hysteresis. As is well known, through the provision of a switching hysteresis in control devices, the frequency of the switching of the actuator can be reduced, wherein, however, at the same time also greater fluctuations of the control variable are also taken into account.

When control limits for the controlling of the average wire feed are reached, the welding speed can be changed and, despite reaching the control limits, a keeping constant of the melt-off efficiency of the consumable welding wire or respectively a keeping constant of the average wire feed can be achieved. On reaching the control limits therefore the welding speed can be adapted through corresponding actuation of the welding robot and for example in build-up welding a consistent layer thickness can nevertheless still be achieved. On the other hand, control limits can also be set deliberately, in order to enable the controlling of the average wire feed or respectively of the melt-off efficiency only in specific limits.

The controlling of the average wire feed can also be deactivated, in order to be able to shut off the controlling of the average wire feed according to the invention in the case of specific welding applications.

The problem according to the invention is also solved by an above-mentioned welding apparatus, wherein the control device is configured furthermore for changing the welding current, the free wire length of the welding wire, the distance of the contact tube of the welding torch from the workpiece (CTWD Contact Tip to Work Distance), and/or the inclination angle of the welding torch as welding parameters in accordance with the deviation of the average measured wire feed from the specified average wire feed as control deviation. Such a welding apparatus is able to be implemented in a relatively simple and economical manner. Reference is to be made to the above description of the welding process with regard to the advantages which are able to be achieved thereby.

Advantageously, a database which is connected to the control device is provided for the depositing of the welding parameters in the form of working points for various melt-off efficiencies. For the most varied of wire feed speeds, this database has a plurality of values for the most varied of welding parameters. Between the working points, an interpolation of the welding parameters takes place, which is carried out for example by the process controller.

The control device preferably has an integrating controller (I-controller) or a proportional-integrating controller (PI-controller).

Furthermore, the control device can be configured for controlling the average wire feed with a maximum specified rate of increase or respectively slew rate, in order to be able to influence the speed of the control.

Advantageously, the control device is configured for controlling the average wire feed with a hysteresis.

When the control device is connected to the welding robot, the welding speed can be changed on reaching control limits for the control of the average wire feed, in order to also be able to achieve a keeping constant of the melt-off efficiency beyond the control limits.

When the input unit has an adjusting member for deactivating the control device, the controlling and keeping constant of the melt-off efficiency according to the invention can also be shut off if required.

For example, the input unit can be formed by a touchscreen on which a corresponding region can also be provided as an adjusting member for deactivation. Such touchscreens therefore constitute a combined input/output unit of the welding apparatus and facilitate the welder in the operation of the welding apparatus.

The input unit can also or additionally be formed by a remote control, in order to be able monitor the welding process from a distance, or respectively to be able to carry out specific adjustments from a distance.

The present invention is explained more closely with the aid of the enclosed drawings. There are shown therein

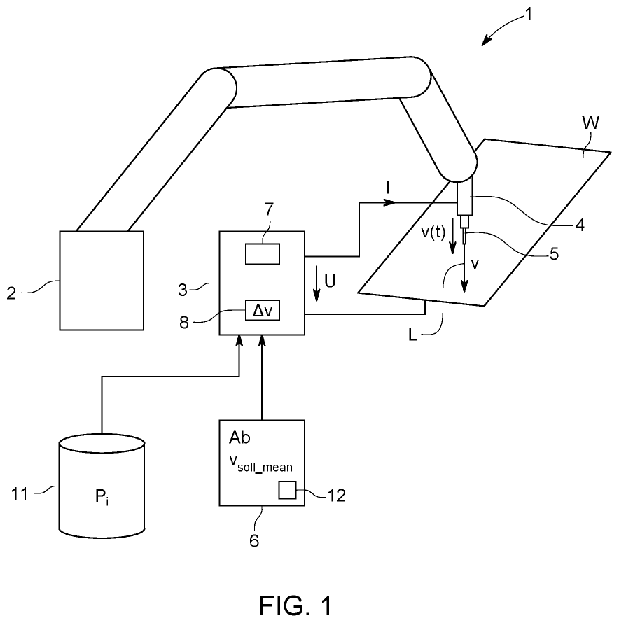

FIG. 1 a block diagram of a welding apparatus with a control device for controlling the wire feed;

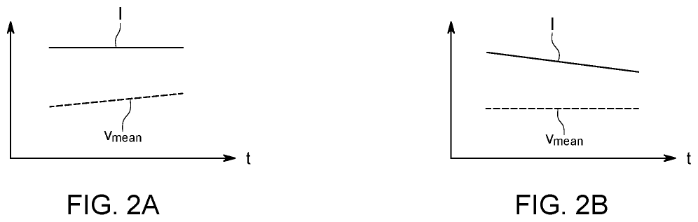

FIGS. 2A and 2B a comparison of the control strategy hitherto and the new control strategy;

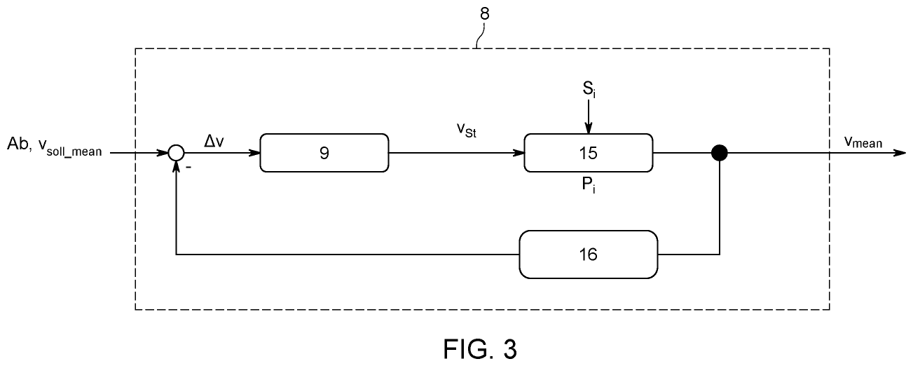

FIG. 3 an embodiment of a control device with an I-controller;

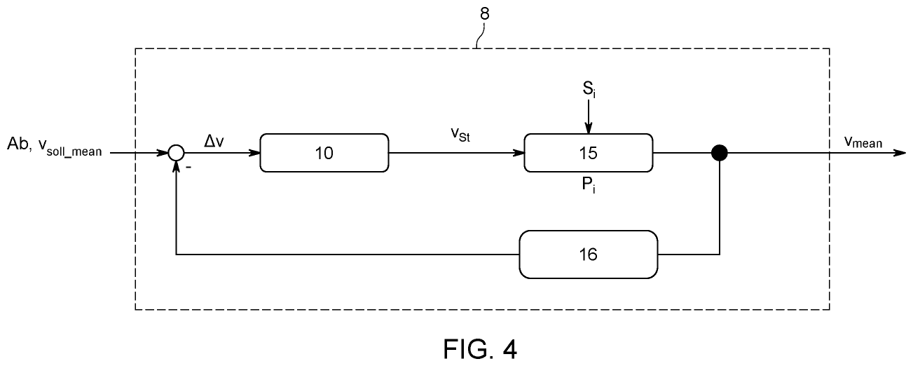

FIG. 4 a further embodiment of a control device with a PI-controller;

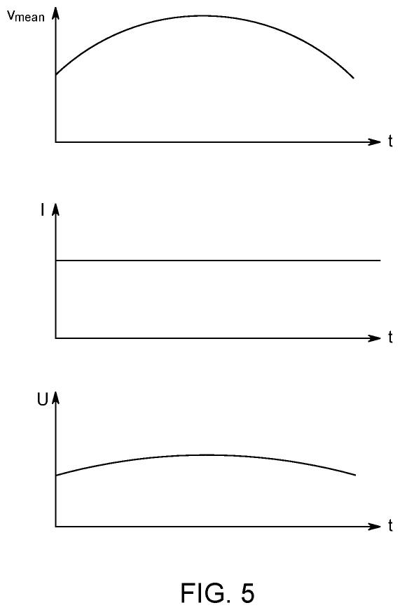

FIG. 5 time diagrams of the average wire feed, of the welding current and of the welding voltage of a welding procedure of the prior art, in which the welding current is kept substantially constant; and

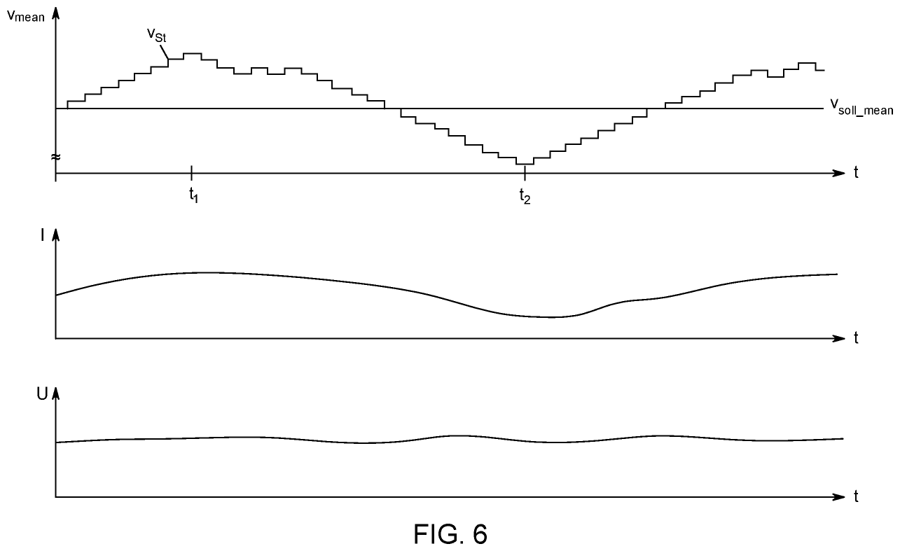

FIG. 6 time diagrams of the control variable of the control device, of the welding current and of the welding voltage of a welding procedure according to the invention, in which the melt-off efficiency of the welding wire is kept substantially constant.

FIG. 1 shows a block diagram of a welding apparatus 1 with a welding torch 4, guided by a welding robot 2, for feeding a consumable welding wire 5 to a workpiece W. The consumable welding wire 5 is supplied via a welding current source 3 with a corresponding welding current I and corresponding welding voltage U for the formation of an arc L between the free end of the welding wire 5 and the workpiece W. The welding process concerns in particular a so-called cold metal transfer (CMT) welding process, wherein a welding procedure is formed by cyclic alternating of an arc phase and a short circuit phase. During the arc phase, the welding wire 5 is moved with a wire feed v(t) in the direction of the workpiece W up to contact with the workpiece W, and subsequently, after formation of a short circuit, during the short circuit phase the wire feeding is reversed and the welding wire 5 is moved away from the workpiece W. A plurality of welding parameters Pᵢ are set for establishing the welding procedure. In particular in build-up welding and in additive manufacture, it is important to achieve a constant melt-off efficiency of the welding wire 5, so that the thickness of the applied metallic material remains substantially constant. Therefore, the average wire feed vₘₑₐₙ is to remain substantially constant corresponding to the desired and preset melt-off efficiency Ab of the welding wire 5. The desired melt-off efficiency Ab of the welding wire 5 or respectively the desired average wire feed v_{soll_mean} of the welding wire 5 is set or selected via an input unit 6, which can also be integrated in the welding current source 3. In build-up welding, the selection or setting of the desired thickness of the material layer which is to be applied would also be possible, wherein here also the speed of the welding robot 2 would be specifiable. A measuring device 7, which can be arranged in the welding current source 3 or in a wire feed unit (not illustrated) separate from the welding current source 3, monitors the latest wire feed v(t) and compares the latter with a specified average wire feed v_{soll_mean} corresponding to the preset melt-off efficiency Ab. Depending on the deviation, the average wire feed vₘₑₐₙ of the welding wire 5 is then controlled in a control device 8 by the welding parameters Pᵢ being changed in accordance with the deviation Δv of the average measured wire feed vₘₑₐₙ from the specified average wire feed v_{soll_mean} as control deviation. The control device 8 can be arranged in the welding current source 3 or outside the welding current source 3. Therefore, depending on the deviation Δv, a shifting of the working point takes place or respectively a shifting of the welding characteristic. The welding parameters Pᵢ are preferably stored in a corresponding database 11. A corresponding interpolation of the values takes place between the stored welding parameters Pᵢ.

FIGS. 2A and 2B shows a comparison of the hitherto control strategy and the new control strategy. FIG. 2A shows the hitherto control, in which the welding current I is kept substantially constant as a function of the time t, and the average wire feed vₘₑₐₙ is adapted accordingly, in order to achieve the constant profile of the welding current I. FIG. 2B shows the control according to the invention of a constant melt-off efficiency Ab of the welding wire or respectively a control of a constant wire feed vₘₑₐₙ. The welding current I is changed so that the substantially constant average wire feed vₘₑₐₙ can be achieved. In the illustrations, in addition to the average wire feed vₘₑₐₙ only the welding current I is presented as a representative welding parameter Pᵢ. In reality, however, the welding process is established by a plurality of welding parameters Pᵢ which are changed accordingly for keeping constant the melt-off efficiency Ab or respectively the average wire feed vₘₑₐₙ.

FIG. 3 shows an embodiment of a control device 8 with an I-controller 9. The desired melt-off efficiency Ab of the consumable welding wire 5 or respectively the corresponding specified average wire feed v_{soll_mean}, which is compared to the measured average wire feed vₘₑₐₙ which if necessary is converted in a converter 16, serves as command variable of the control loop. The resulting control deviation Δv as difference of the specified average wire feed v_{soll_mean} and of the average measured wire feed vₘₑₐₙ is fed to the controller, which is formed here by the integrating controller (I-controller) 9. The corresponding control variable v_{St} is then fed to the controlled system 15, where the welding parameters Pᵢ are changed so that the control variable, the average wire feed vₘₑₐₙ, corresponds as much as possible to the desired value. In an actual welding procedure, of course interference variables Si act on the controlled system 15. These interference variables concern for example the free wire length (stickout) of the welding wire, the distance of the contact tube from the welding torch (CTWD Contact Tip to Work Distance), the temperature, the inclination angle of the welding torch 4, the protective gas, impurities, the welding speed, and much more. The control device 8 according to the invention thus enables the keeping constant of a desired melt-off efficiency Ab of the consumable welding wire 5 by corresponding adapting or respectively changing of the welding parameters Pᵢ. The I-controller 9 in the control loop brings the control variable, therefore the average wire feed vₘₑₐₙ, to the target value v_{soll_mean}, without a control difference remaining. Through the integration of the control deviation Δv in the I-controller 9, a longer adjustment time is required which, however, does not bring about any disadvantage in the application according to the object.

FIG. 4 shows a further embodiment of a control device 8, wherein instead of the I-controller 9 according to FIG. 3, a proportional-integrating controller (PI-controller) 10 is arranged. In contrast to the I-controller 9, the PI-controller 10 is somewhat faster. Otherwise, the description in accordance with FIG. 3 is to be applied to FIG. 4.

FIG. 5 shows the time diagrams of the average wire feed vₘₑₐₙ, of the welding current I and of the welding voltage U of a welding procedure of the prior art, in which the welding current I is kept substantially constant. Accordingly, other welding parameters Pᵢ, here the welding voltage U and the average wire feed vₘₑₐₙ, are changed so that the desired constant profile of the welding current I can be achieved. In an actual welding procedure, a plurality of welding parameters Pᵢ is necessary for establishing the welding procedure and is stored in the form of working points or welding characteristics which must be adapted accordingly depending on the application, in order to be able to achieve the desired welding result.

FIG. 6 shows now the time diagrams of the control variable v_{St} of the control device, of the welding current I and of the welding voltage U of a welding procedure according to the invention, in which the melt-off efficiency Ab of the consumable welding wire 5 is kept substantially constant. The horizontal line in the time diagram of the average wire feed vₘₑₐₙ represents the target value of the specified average wire feed v_{soll_mean}, which corresponds to the desired melt-off efficiency Ab of the consumable welding wire 5, and which is to be kept substantially constant. The melt-off efficiency Ab corresponds to the amount of melted off material of the welding wire 5 per unit of time and can also be described in an equivalent manner by a particular average wire feed v_{soll_mean}. Under the prerequisite of a uniform welding speed, in the case of a constant melt-off efficiency Ab a uniform thickness of the weld seam results, or in the case of build-up welding and in the case of additive manufacture a uniform thickness of the applied material layer results. In the illustrated example, the distance of the welding torch from the workpiece (CTWD Contact Tip to Work Distance) for example is reduced as interference variable of for example of 10 mm (point in time t₁) to 20 mm (point in time t₂) and subsequently (starting from point in time t₂) again to 10 mm. Through corresponding adjusting of the control variable v_{St} of the control device 8, the controller counteracts this interference variable, in order to be able to keep constant the control variable and thus the specified melt-off efficiency Ab or respectively the desired target value of the wire feed v_{soll_mean}. With increasing CTWD starting from point in time t₁, the melt-off efficiency Ab would increase. In order to counteract this, the control variable v_{St} of the controller, therefore the specification of the wire feed, is reduced in stages, and also the welding current I is lowered. Accordingly, the working point is changed accordingly, in order to be able to keep the target value of the wire feed. In the subsequent reduction of the CTWD as interference variable starting from point in time t₂, again the control variable v_{St} of the control device is increased in stages and the welding current is increased, whereby the desired control variable can be kept constant. Accordingly, the control variable of the controller is increased again in stages and the welding current I is increased or respectively the working point is shifted accordingly in order to be able to keep constant the melt-off efficiency Ab of the welding wire 5. In the illustrated example, every 100 ms for example a change of the control variable v_{St} takes place. The average wire feed vₘₑₐₙ is illustrated here on a greatly enlarged scale. In reality, not only the presented welding parameters Pᵢ, but a plurality of welding parameters Pᵢ is necessary for establishing the welding procedure, which must be adapted accordingly in order to be able to achieve the desired welding result.

1. A welding process, in particular a cold metal transfer (CMT) welding process for build-up welding, with a consumable welding wire (5), which is fed to a welding torch (4) guided by a welding robot (2), wherein a welding procedure is formed by cyclic alternating of an arc phase and a short circuit phase, and the welding wire (5) is moved in the direction of a workpiece (W) during the arc phase up to contact with a workpiece (W) and subsequently, after formation of a short circuit, during the short circuit phase the wire feeding is reversed and the welding wire (5) is moved away from the workpiece (W), and wherein to establish the welding procedure a plurality of welding parameters (Pᵢ) are set, wherein during the welding procedure a preset melt-off efficiency (Ab) of the welding wire (5) is kept substantially constant, by the average wire feed (vₘₑₐₙ) of the welding wire (5) being controlled, wherein the latest wire feed (v(t)) is measured, the average measured wire feed (vₘₑₐₙ) is compared with a specified average wire feed (v_{soll_mean}) corresponding to the desired melt-off efficiency (Ab), wherein in accordance with the deviation (Δv) of the average measured wire feed (vₘₑₐₙ) from the specified average wire feed (v_{soll_mean}) as control deviation, the welding current (I), the free wire length of the welding wire (5), the distance of the contact tube of the welding torch from the workpiece (CTWD Contact Tip to Work Distance) and/or the inclination angle of the welding torch (4) are changed as welding parameters (Pᵢ).

2. The welding process according to claim 1, wherein the welding parameters (Pᵢ) are stored in the form of working points for different melt-off efficiencies (Ab) and are selected according to the control deviation or respectively are interpolated between the working points.

3. The welding process according to claim 1, wherein the latest wire feed (v(t)) is measured every 1 μs to 50 μs.

4. The welding process according to claim 3, wherein the measured latest wire feed (v(t)) is averaged over a time span between 10 ms and 1000 ms, in particular in blocks or continuously.

5. The welding process according to claim 1, wherein the average wire feed (vₘₑₐₙ) is controlled with a maximum specified rate of increase.

6. The welding process according to claim 1, wherein the average wire feed (vₘₑₐₙ) is controlled with a hysteresis.

7. The welding process according to claim 1, wherein the welding speed (x(t)) is changed when control limits for the controlling of the average wire feed (vₘₑₐₙ) are reached.

8. The welding process according to claim 1, wherein the controlling of the average wire feed (vₘₑₐₙ) is deactivated.

9. A welding apparatus (1), with a welding torch (4) guided by a welding robot (2), for feeding a consumable welding wire (5) to a workpiece (W), and with a welding current source (3) for carrying out a welding process, in particular a cold metal transfer (CMT) welding process for build-up welding, wherein a welding procedure is formed by cyclic alternating of an arc phase and a short circuit phase, and the welding wire (5) is moved during the arc phase in the direction of a workpiece (W) up to contact with a workpiece (W), and subsequently, after formation of a short circuit, during the short circuit phase, the wire feeding is reversed and the welding wire (5) is moved away from the workpiece (W), and wherein to establish the welding procedure a plurality of welding parameters (Pᵢ) are able to be set, wherein there is provided an input unit (6) for inputting or selecting a desired melt-off efficiency (Ab) of the welding wire (5), a measuring device (7) for measuring the latest wire feed (v(t)) and a control device (8) for controlling the average wire feed (vₘₑₐₙ) of the welding wire (5) to keep constant the desired melt-off efficiency (Ab), and the control device (8) is configured for comparing the average measured wire feed (vₘₑₐₙ) with a specified average wire feed (v_{soll_mean}) corresponding to the preset melt-off efficiency (Ab), wherein the control device (8) is furthermore configured for changing the welding current (I), the free wire length of the welding wire (5), the distance of the contact tube of the welding torch from the workpiece (CTWD Contact Tip to Work Distance), and/or the inclination angle of the welding torch (4) as welding parameters (Pᵢ) in accordance with the deviation (Δv) of the average measured wire feed (vₘₑₐₙ) from the specified average wire feed (v_{soll_mean}) as control deviation.

10. The welding apparatus (1) according to claim 9, wherein a database (11), connected to the control device (8), is provided for depositing the welding parameters (Pᵢ) in the form of working points for different melt-off efficiencies (Ab).

11. The welding apparatus (1) according to claim 9, wherein the control device (8) has an integrating controller (9) or a proportional-integrating controller (10).

12. The welding apparatus (1) according to claim 9, wherein the control device (8) is connected to the welding robot (2), so that the welding speed (x(t)) is able to be changed on reaching control limits for the controlling of the average wire feed (vₘₑₐₙ).

13. The welding apparatus (1) according to claim 9, wherein the input unit (6) has an adjusting member (12) for deactivating the control device (8).
